(19) United States
(12) Patent Application Publication
(10) Pub. No.: US 2025/0069346 A1
(43) Pub. Date: Feb. 27, 2025

(54) INTERACTIVELY PLACING OBJECTS ON A VIRTUAL STAGE

(71) Applicants: Sony Group Corporation, Tokyo (JP); Sony Pictures Entertainment Inc., Culver City, CA (US)

(72) Inventors: Tobias Anderberg, Los Angeles, CA (US); Joseph Wise, Los Angeles, CA (US)

(21) Appl. No.: 18/237,632

(22) Filed: Aug. 24, 2023

(51) Int. Cl. G06T 19/20; G06F 3/01

(52) U.S. Cl. CPC G06T 19/20; G06F 3/011; G06T 2200/24; G06T 2219/2004

(57) ABSTRACT

Tracking a control object on a stage for a virtual production, including: tracking a control object on the stage with a system that tracks at least one camera used in the virtual production; identifying a location in a virtual environment using tracking information of the control object; and placing virtual assets at the identified location in the virtual environment.

### BACKGROUND

### Field

The present disclosure relates to tracking a control object, and more specifically, to tracking the control object on a stage for a virtual production.

### Background

In a virtual production, photorealistic sets are displayed on large LED walls behind physical sets using the real-time rendering capabilities of real-time 3-D engines. The cameras are synchronized with the 3-D engines for enhanced realism and depth of perspective. During a shoot on the virtual production, communication between virtual artists and traditional set designers (or the director of photography) may be difficult. In the current workflow, if a virtual object needs to be placed in the world, the set designer needs to verbally communicate with the virtual artist to guide them on placement of virtual assets. Furthermore, to use virtual light cards (i.e., a virtual light placed on the screen to light practical subjects), the director of photography also needs to verbally communicate with the virtual artist to guide them on placement of the virtual light card. This may be inefficient as well as inaccurate in a scenario where efficiency and accuracy are vital.

### SUMMARY

The present disclosure implements techniques for tracking a control object on a stage for a virtual production and interactively placing virtual assets at an identified location in a virtual environment.

In one implementation, a method for tracking a control object on a stage for a virtual production is disclosed. The method includes: tracking a control object on the stage with a system that tracks at least one camera used in the virtual production; identifying a location in a virtual environment using tracking information of the control object; and placing virtual assets at the identified location in the virtual environment.

In another implementation, a system to track a control object on a stage for a virtual production is disclosed. The system includes: a control object; a tracking device to track the control object on the stage, wherein the tracking device tracks at least one camera used in the virtual production; and a computer system to identify a location in a virtual environment displayed on an LED wall using tracking information of the control object obtained by the tracking device, wherein the computer system places virtual assets at the identified location in the virtual environment.

In yet another implementation, a non-transitory computer-readable storage medium storing a computer program to track a control object on a stage for a virtual production includes executable instructions that cause a computer to: track a control object on the stage with a system that tracks at least one camera used in the virtual production; identify a location in a virtual environment using tracking information of the control object; and place virtual assets at the identified location in the virtual environment.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram of a process for tracking a control object on stage for a virtual production in accordance with one implementation of the present disclosure;

FIG. 2 is an illustration of a system for tracking a control object on stage for a virtual production in accordance with one implementation of the present disclosure;

FIG. 3 is a block diagram of a system for tracking a control object on stage for a virtual production in accordance with one implementation of the present disclosure; and

FIG. 4A is a representation of a computer system and a user in accordance with an implementation of the present disclosure; and

FIG. 4B is a functional block diagram illustrating the computer system 400 hosting the tracking application in accordance with an implementation of the present disclosure.

### DETAILED DESCRIPTION

As described above, in the current workflow of a virtual production, if a virtual object needs to be placed in the world, the set designer needs to verbally communicate with the virtual artist to guide them on placement of virtual assets. This may be inefficient as well as inaccurate in a scenario where efficiency and accuracy are vital.

To address the issues with the conventional way for the set designer to verbally communicate with the virtual artist to guide them on placement of virtual assets, implementations of the present disclosure provide a technique for tracking an object on stage through the same system that tracks the camera. These implementations enable a user to use the tracked object to “point” into the screen by virtually ray casting into the scene and either placing the virtual assets and light cards or to signal to the virtual artist where to place the assets. In one implementation, the tracked object may act as a virtual “laser pointer.”

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, a technique for tracking an object (e.g., a virtual laser pointer) on stage is disclosed. The technique includes: tracking a control object on stage with the same system that tracks the camera; using the control object tracking information to identify a location and/or object in the stage or virtual environment; and placing or adjusting assets or light cards using the identified location.

In one example implementation, the tracked object is a pointer to indicate object and/or location. The technique tracks an object like a wand (or a finger) solely for the purpose of creating a virtual laser pointer in the scene. A virtual ray may be cast from the tip of the wand creating a visible line in the virtual environment that the artists may see on their workstation to help guide the placement of objects. This may greatly increase the efficiency and accuracy of the workflow. In an alternative, the tracked object includes finger, hand, arm, markers on a hand to create a line (like a wand), eyeline, voice, object tags, and combinations (for example, drop a pin or mark with a wand/pointer and add verbal notes/commands).

In another example implementation, the technique uses a tracked tablet computer instead of a wand. The tablet may include software that allows the user to pick objects (3D models, lights, light cards, etc.) and place them in the virtual world based on a ray cast from the tracked tablet computer into the virtual scene. Light cards would be placed directly at the intersection of the ray cast and the virtual stage. The user may control various aspects of the virtual objects (color, brightness, scale, rotation, etc.) directly on the tablet computer. If needed, the virtual artist may then further refine placement and attributes by editing the objects in the virtual environment on the artist's workstation.

In a further example implementation, the added information may be visible live on set in both the wall image and through an AR or AR-like system, depending on the user's choice. The added information may also be togglable by the user to pick when it is visible so that it may be turned off when recording through the camera. This added information may apply to physical objects on the set, especially with AR or AR-like system. It would be useful to have this added information for the artist on their workstation so they may see how the physical set pieces line up with the virtual world.

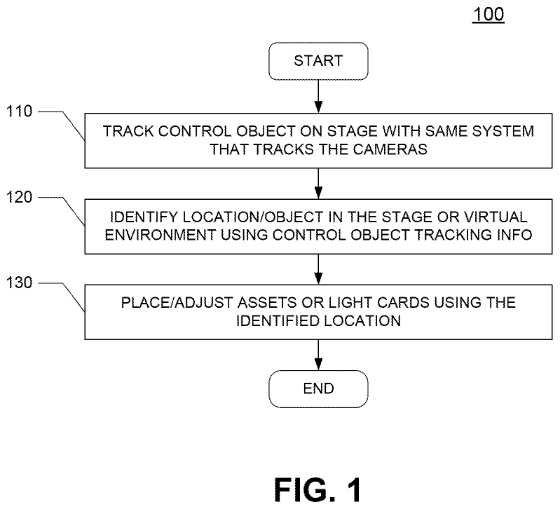

FIG. 1 is a flow diagram of a process 100 for tracking a control object on stage for a virtual production in accordance with one implementation of the present disclosure. In one implementation, the process 100 runs on a computer system which tracks and processes the control object.

In the illustrated implementation of FIG. 1, a process 100 for tracking a control object (e.g., a virtual laser pointer) on stage for a virtual production is disclosed. The process 100 includes tracking a control object on stage, at block 110, with the same system that tracks the camera(s). The location/object in the stage or virtual environment is then identified, at block 120, using the control object tracking information obtained, at block 110. The virtual assets are placed or adjusted at the identified location/object, at block 130. In one implementation, the blocks 110, 120, 130 are configured entirely with hardware including one or more digital signal processors (DSPs), general purpose microprocessors, application specific integrated circuits (ASICs), field programmable logic arrays (FPGAs), or other equivalent integrated or discrete logic circuitry.

In one implementation, the control object tracked at block 110 is a pointer to indicate a location and/or object where virtual assets including light cards (i.e., a virtual light placed on a surface of the screen to aid the lighting of a physical subject on stage) are to be placed. In one example, a control object like a wand (or a finger) may be tracked solely for the purpose of creating a virtual laser pointer in a scene. A virtual ray may be cast from the tip of the wand creating a visible line in the virtual environment that the virtual artist may see on the artist's workstation to help guide the placement of the virtual assets. This may greatly increase the efficiency and accuracy of the workflow of the virtual production. In an alternative, the tracked object includes finger, hand, arm, markers on a hand to create a line (like a wand), eyeline, voice, object tags, and combinations (for example, drop a pin or mark with a wand/pointer and add verbal notes/commands).

In another implementation, the process 100 for tracking a control object uses a tablet computer instead of a wand. The tracked tablet may include software that allows a user to pick objects (3D models, lights, light cards, etc.) and place them in the virtual world based on a ray cast from the tracked tablet computer into the virtual scene. The light cards may be placed directly at the intersection of the ray cast and the virtual stage. The user may control various aspects of the virtual objects (color, brightness, scale, rotation, etc.) directly on the tablet computer. If needed, the virtual artist may then further refine placement and attributes by editing the objects in the virtual environment on the artist's workstation.

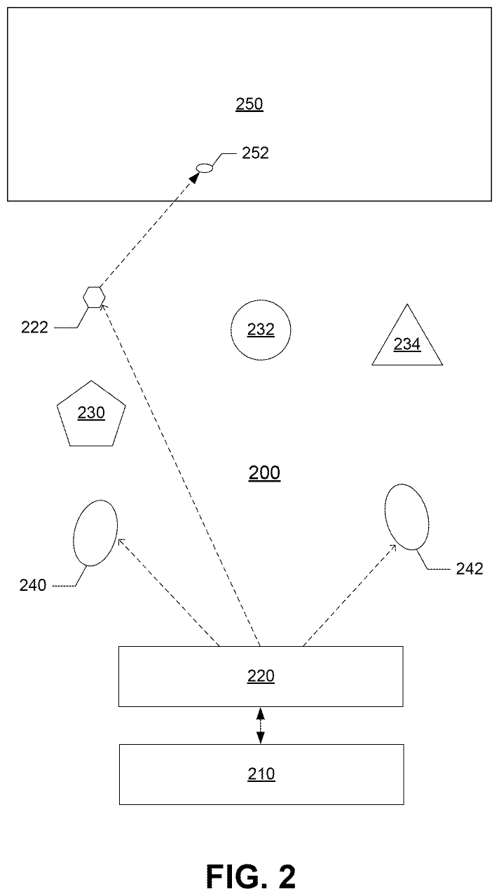

FIG. 2 is an illustration of a system 200 for tracking a control object 222 on stage for a virtual production in accordance with one implementation of the present disclosure. In one implementation, the system 200 is implemented on a computer system 210 to track and process the control object 222. In one implementation, an LED wall 250 is situated behind the stage.

In the illustrated implementation of FIG. 2, the system 200 includes a computer system 210, a tracking device 220 and a control object 222. In one implementation, the tracking device 220 is configured to track the control object 222 on stage, which may include physical props 230, 232, 234. The tracking device 220 may also track the cameras 240, 242.

In one implementation, the computer system 210 identifies the location/object 252 in the stage or virtual environment (displayed on the LED wall 250) using the control object tracking information obtained by the tracking device 220. The computer system 210 may then place or adjust the virtual assets at the identified location/object. In one implementation, the system 200 further includes a communication device (not shown) configured for communication between the set designer and the virtual artist (who is present remotely from the set designer). In one implementation, the set designer is in possession of the control object 222. In one implementation, the virtual artist places the virtual assets in the virtual environment according to the pointer and/or verbal directions given by the set designer.

In one implementation, the control object 222 tracked by the tracking device 220 is a pointer to indicate a location and/or object 252 where the virtual assets including light cards are to be placed. In one example, the control object 222 includes a wand (or a finger) that is tracked solely for the purpose of creating a virtual laser pointer in a scene. A virtual ray may be cast from the tip of the wand creating a visible line in the virtual environment that the virtual artist may see on the virtual artist's workstation to help guide the placement of the virtual assets. This may greatly increase the efficiency and accuracy of the workflow of the virtual production. In an alternative, the tracked object includes finger, hand, arm, markers on a hand to create a line (like a wand), eyeline, voice, object tags, and combinations (for example, drop a pin or mark with a wand/pointer and add verbal notes/commands).

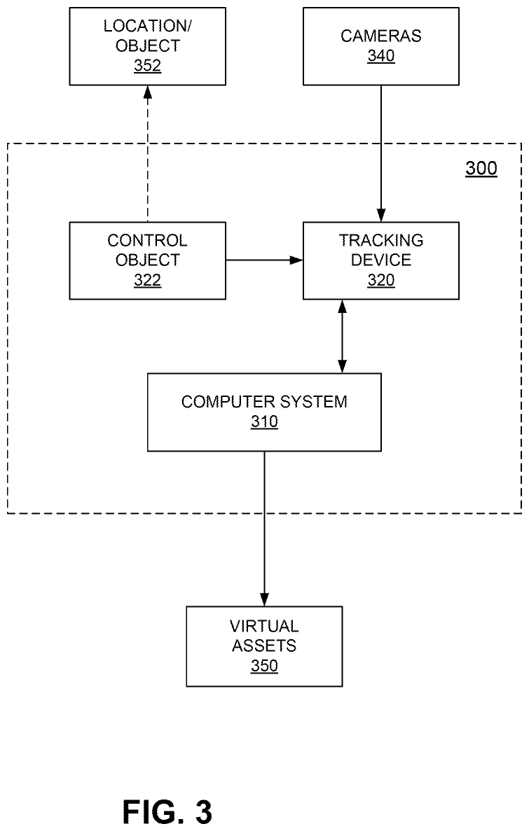

FIG. 3 is a block diagram of a system 300 for tracking a control object 322 on stage for a virtual production in accordance with one implementation of the present disclosure. In the illustrated implementation of FIG. 3, the system 300 includes a computer system 310, a tracking device 320 and a control object 322. In one implementation, the tracking device 320 is configured to track the control object 322 on stage. The tracking device 320 may also track the cameras 340.

In one implementation, the computer system 310 identifies the location/object 352 in the stage or virtual environment (displayed on the LED wall) using the control object tracking information obtained by the tracking device 320. The computer system 310 may then place or adjust the virtual assets 350 at the identified location/object 352. In one implementation, the system 300 further includes a communication device (not shown) configured for communication between the set designer and the virtual artist (who is present remotely from the set designer). In one implementation, the set designer is in possession of the control object 322. In one implementation, the virtual artist places the virtual assets 350 in the virtual environment according to the pointer and/or verbal directions given by the set designer.

In one implementation, the control object 322 tracked by the tracking device 320 is a pointer to indicate the location and/or object 352 where the virtual assets 350 including light cards are to be placed. In one example, the control object 322 includes a wand (or a finger) that is tracked solely for the purpose of creating a virtual laser pointer in a scene. A virtual ray may be cast from the tip of the wand creating a visible line in the virtual environment that the virtual artist may see on the virtual artist's workstation to help guide the placement of the virtual assets 350. This may greatly increase the efficiency and accuracy of the workflow of the virtual production.

In another implementation, the control object 322 is a tablet computer rather than a wand. The tracked tablet may include software that allows a user to pick objects (3D models, lights, light cards, etc.) and place them in the virtual world based on a ray cast from the tracked tablet computer into the virtual scene. The light cards may be placed directly at the intersection of the ray cast and the virtual stage. The user may control various aspects of the virtual objects (color, brightness, scale, rotation, etc.) directly on the tablet computer. If needed, the virtual artist may then further refine placement and attributes by editing the objects in the virtual environment on the artist's workstation.

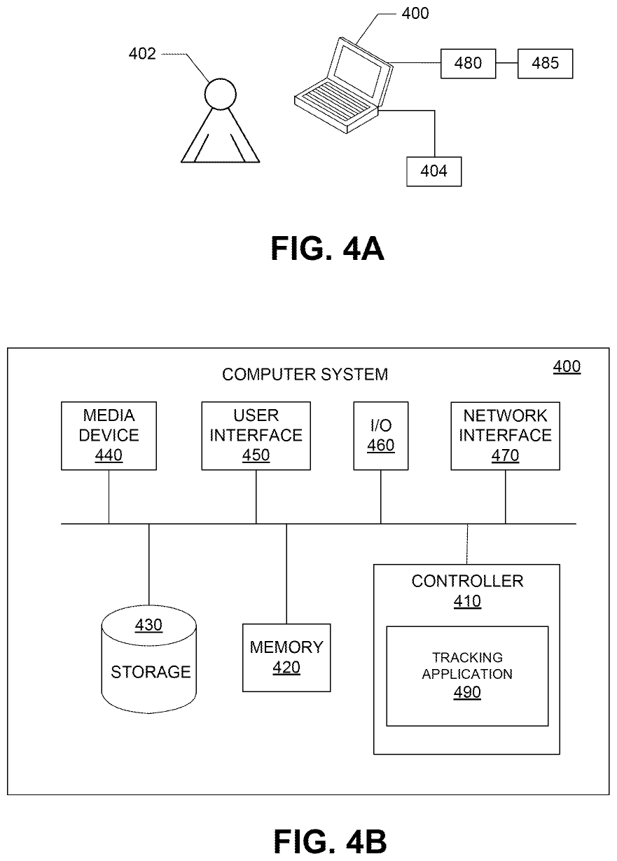

FIG. 4A is a representation of a computer system 400 and a user 402 in accordance with an implementation of the present disclosure. The user 402 uses the computer system 400 to implement a tracking application 490 to track a control object on stage for a virtual production with respect to the process 100 of FIG. 1 and the system 300 of FIG. 3.

The computer system 400 stores and executes the tracking application 490 of FIG. 4B. In addition, the computer system 400 may be in communication with a software program 404. Software program 404 may include the software code for the tracking application 490. Software program 404 may be loaded on an external medium such as a CD, DVD, or a storage drive, as will be explained further below.

Furthermore, the computer system 400 may be connected to a network 480. The network 480 may be connected in various different architectures, for example, client-server architecture, a Peer-to-Peer network architecture, or other type of architectures. For example, network 480 may be in communication with a server 485 that coordinates engines and data used within the tracking application 490. Also, the network may be different types of networks. For example, the network 480 may be the Internet, a Local Area Network or any variations of Local Area Network, a Wide Area Network, a Metropolitan Area Network, an Intranet or Extranet, or a wireless network.

FIG. 4B is a functional block diagram illustrating the computer system 400 hosting the tracking application 490 in accordance with an implementation of the present disclosure. A controller 410 is a programmable processor and controls the operation of the computer system 400 and its components. The controller 410 loads instructions (e.g., in the form of a computer program) from the memory 420 or an embedded controller memory (not shown) and executes these instructions to control the system, such as to provide the data processing. In its execution, the controller 410 provides the tracking application 490 with a software system. Alternatively, this service may be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data either temporarily or for long periods of time for use by the other components of the computer system 400. For example, storage 430 stores data used by the tracking application 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. In another implementation, the user interface 450 also includes a headset worn by the user and used to collect eye movements as user inputs. The controller 410 uses input from the user 402 to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system may be used (e.g., different bus or storage configurations or a multi-processor configuration).

In one particular implementation, a method for tracking a control object on a stage for a virtual production is disclosed. The method includes: tracking a control object on the stage with a system that tracks at least one camera used in the virtual production; identifying a location in a virtual environment using tracking information of the control object; and placing virtual assets at the identified location in the virtual environment.

In one implementation, the virtual assets include light cards. In one implementation, the tracked control object includes one of finger, hand, arm, markers on a hand, eyeline, voice, or object tags. In one implementation, the control object is a pointer to indicate the location. In one implementation, the pointer is tracked to create a virtual laser pointer in the virtual environment by casting a virtual ray from a tip of the pointer to create a visible line. In one implementation, the virtual ray guides a virtual artist to place the virtual assets at the identified location. In one implementation, the tracked control object includes a tablet computer including software that enables a user to pick and place virtual objects in the virtual environment based on the virtual ray from the tracked tablet computer to a scene in the virtual environment. In one implementation, the virtual objects include at least one of 3D models, lights, and light cards. In one implementation, the user controls various aspects of the virtual objects directly on the tablet computer. In one implementation, the various aspects include at least one of color, brightness, scale, and rotation.

In another particular implementation, a system to track a control object on a stage for a virtual production is disclosed. The system includes: a control object; a tracking device to track the control object on the stage, wherein the tracking device tracks at least one camera used in the virtual production; and a computer system to identify a location in a virtual environment displayed on an LED wall using tracking information of the control object obtained by the tracking device, wherein the computer system places virtual assets at the identified location in the virtual environment.

In one implementation, the virtual assets include light cards. In one implementation, the tracked control object includes one of finger, hand, arm, markers on a hand, eyeline, voice, or object tags. In one implementation, the control object is a pointer to indicate the location. In one implementation, the pointer includes a virtual laser pointer in the virtual environment to cast a virtual ray from a tip of the pointer to create a visible line. In one implementation, the tracked control object includes a tablet computer including software that enables a user to pick and place virtual objects in the virtual environment based on the virtual ray from the tracked tablet computer to a scene in the virtual environment. In one implementation, the virtual objects include at least one of 3D models, lights, and light cards.

In yet another particular implementation, a non-transitory computer-readable storage medium storing a computer program to track a control object on a stage for a virtual production includes executable instructions that cause a computer to: track a control object on the stage with a system that tracks at least one camera used in the virtual production; identify a location in a virtual environment using tracking information of the control object; and place virtual assets at the identified location in the virtual environment.

In one implementation, the non-transitory computer-readable storage medium further includes executable instructions that cause the computer to create a virtual laser pointer in the virtual environment by casting a virtual ray from a tip of the control object to create a visible line. In one implementation, the executable instructions that cause the computer to place virtual assets at the identified location in the virtual environment include executable instructions that cause the computer to guide a virtual artist to place the virtual assets at the identified location using the virtual ray.

The description herein of the disclosed implementations is provided to enable any person skilled in the art to make or use the present disclosure. Numerous modifications to these implementations would be readily apparent to those skilled in the art, and the principles defined herein may be applied to other implementations without departing from the spirit or scope of the present disclosure. For example, although several implementations have been discussed in the context of virtual production for movies and television, additional implementations may include virtual production for music videos, games, and other related media presentations. Further implementations may include production with AR tools to present virtual assets or notes on stage assets. Thus, the present disclosure is not intended to be limited to the implementations shown herein but is to be accorded the widest scope consistent with the principal and novel features disclosed herein. Accordingly, additional variations and implementations are also possible.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for tracking a control object on a stage for a virtual production, the method comprising:
tracking a control object on the stage with a system that tracks at least one camera used in the virtual production;
identifying a location in a virtual environment using tracking information of the control object; and
placing virtual assets at the identified location in the virtual environment.

2. The method of claim 1, wherein the virtual assets include light cards.

3. The method of claim 1, wherein the tracked control object includes one of:
finger, hand, arm, markers on a hand, eyeline, voice, or object tags.

4. The method of claim 1, wherein the control object is a pointer to indicate the location.

5. The method of claim 4, wherein the pointer is tracked to create a virtual laser pointer in the virtual environment by casting a virtual ray from a tip of the pointer to create a visible line.

6. The method of claim 5, wherein the virtual ray guides a virtual artist to place the virtual assets at the identified location.

7. The method of claim 5, wherein the tracked control object includes
a tablet computer including software that enables a user to pick and place virtual objects in the virtual environment based on the virtual ray from the tracked tablet computer to a scene in the virtual environment.

8. The method of claim 7, wherein the virtual objects include at least one of 3D models, lights, and light cards.

9. The method of claim 7, wherein the user controls various aspects of the virtual objects directly on the tablet computer.

10. The method of claim 9, wherein the various aspects include at least one of color, brightness, scale, and rotation.

11. A system to track a control object on a stage for a virtual production, the system comprising:
a control object;
a tracking device to track the control object on the stage, wherein the tracking device tracks at least one camera used in the virtual production; and
a computer system to identify a location in a virtual environment displayed on an LED wall using tracking information of the control object obtained by the tracking device,
wherein the computer system places virtual assets at the identified location in the virtual environment.

12. The system of claim 11, wherein the virtual assets include light cards.

13. The system of claim 11, wherein the tracked control object includes one of:
finger, hand, arm, markers on a hand, eyeline, voice, or object tags.

14. The system of claim 11, wherein the control object is a pointer to indicate the location.

15. The system of claim 14, wherein the pointer includes a virtual laser pointer in the virtual environment to cast a virtual ray from a tip of the pointer to create a visible line.

16. The system of claim 15, wherein the tracked control object includes a tablet computer including software that enables a user to pick and place virtual objects in the virtual environment based on the virtual ray from the tracked tablet computer to a scene in the virtual environment.

17. The system of claim 16, wherein the virtual objects include at least one of 3D models, lights, and light cards.

18. A non-transitory computer-readable storage medium storing a computer program to track a control object on a stage for a virtual production, the computer program comprising executable instructions that cause a computer to:
track a control object on the stage with a system that tracks at least one camera used in the virtual production;
identify a location in a virtual environment using tracking information of the control object; and
place virtual assets at the identified location in the virtual environment.

19. The non-transitory computer-readable storage medium of claim 18, further comprising executable instructions that cause the computer to
create a virtual laser pointer in the virtual environment by casting a virtual ray from a tip of the control object to create a visible line.

20. The non-transitory computer-readable storage medium of claim 17, wherein executable instructions that cause the computer to place virtual assets at the identified location in the virtual environment include executable instructions that cause the computer to
guide a virtual artist to place the virtual assets at the identified location using the virtual ray.
